(19) United States
(12) Patent Application Publication
(10) Pub. No.: US 2012/0288286 A1
(43) Pub. Date: Nov. 15, 2012

(54) OPTICAL RECEIVER FOR AMPLITUDE-MODULATED SIGNALS

(75) Inventors: Vincent E. Houtsma, New Providence, NJ (US); Nils G. Weimann, Gillette, NJ (US)

(73) Assignee: ALCATEL-LUCENT USA INC., Murray Hill, NJ (US)

(21) Appl. No.: 13/106,619

(22) Filed: May 12, 2011

(51) Int. Cl. H04B 10/06

(52) U.S. Cl. 398/202

(57) ABSTRACT

An optical receiver that uses a coherent optical quadrature-detection scheme to demodulate an amplitude-modulated optical input signal in a manner that enables the use of a free-running optical local-oscillator source. The optical receiver employs a signal combiner that combines, into an electrical output signal, the in-phase and quadrature-phase electrical signals generated as a result of the quadrature detection of the optical input signal. Depending on the frequency offset between the local-oscillator signal and the input signal, the electrical output signal produced by the signal combiner can be a desired baseband signal or an intermediate-frequency signal. The latter signal can be demodulated to recover the baseband signal in a relatively straightforward manner, e.g., using a conventional intermediate-frequency electrical demodulator coupled to the signal combiner.

### BACKGROUND

1. Field of the Invention

The present invention relates to optical communication equipment and, more specifically but not exclusively, to optical receivers for suppressed-carrier amplitude-modulated signals.

2. Description of the Related Art

This section introduces aspects that may help facilitate a better understanding of the invention(s). Accordingly, the statements of this section are to be read in this light and are not to be understood as admissions about what is in the prior art or what is not in the prior art.

Suppressed-carrier amplitude modulation (SC-AM) is a transmission format in which the transmitted signal has an amplitude that is relatively low at the carrier frequency, e.g., the signal may be substantially suppressed at the carrier frequency. Suppressed-carrier amplitude modulation may be advantageous over other amplitude-modulation (AM) formats, for example, because most of the signal's optical power is contained in the information-carrying frequency sideband(s) as opposed to being distributed between the frequency sideband(s) and the carrier-frequency component. This property of suppressed-carrier signals can be used, e.g., to increase the relevant signal power and/or transmission distance compared to those of other amplitude-modulated signals.

To demodulate a received SC-AM signal, mixing with a carrier signal (e.g., a CW laser beam) is typically performed at the optical receiver. A typical optical receiver uses a directional coupler (e.g., a 2×2 optical-signal mixer) to mix the received SC-AM signal with an optical local-oscillator (OLO) signal, with the latter having about the same frequency as the (suppressed) optical-carrier wave of the received signal. Disadvantageously, any phase fluctuations, e.g., caused by the phase noise and/or fluctuations in the frequency offset between the OLO and carrier signals, can reduce the power of the resulting baseband signal and/or even render the corresponding message signal completely undecodable. However, circuits that enable an OLO source to be phase- and frequency-locked to the optical-carrier wave are relatively complex and expensive.

### SUMMARY

Various embodiments of an optical receiver use a coherent optical quadrature-detection scheme to demodulate an amplitude-modulated optical input signal in a manner that enables the use of a free-running optical local-oscillator source. The optical receiver employs a signal combiner that combines, into an electrical output signal, the in-phase and quadrature-phase electrical signals generated as a result of the quadrature detection of the optical input signal. Depending on the frequency offset between the local-oscillator signal and the input signal, the electrical output signal produced by the signal combiner can be a desired baseband signal or an intermediate-frequency signal. The latter signal can be demodulated to recover the baseband signal in a relatively straightforward manner, e.g., using a conventional intermediate-frequency electrical demodulator coupled to the signal combiner. Advantageously, the power of the electrical output signal produced by the signal combiner is often relatively stable and insensitive to phase and/or frequency fluctuations caused by the free-running configuration of the optical local-oscillator source.

According to one embodiment, provided is an optical receiver having an optical hybrid configured to mix an optical signal received at a first optical input port thereof with an optical local-oscillator signal received at a second optical input port thereof to generate first, second, third, and fourth mixed optical signals at respective first, second, third and fourth optical output ports thereof. The optical receiver further has a first optical-to-electrical (O/E) converter including first and second photo-detectors connected to receive optical signals from the respective first and second optical output ports, the first O/E converter having a first electrical port that outputs a first electrical signal representative of a difference between electrical signals produced by the respective first and second photo-detectors; and a second O/E converter including third and fourth photo-detectors connected to receive optical signals from the respective third and fourth optical output ports, the second O/E converter having a second electrical port that outputs a second electrical signal representative of a difference between electrical signals produced by the respective third and fourth photo-detectors. The optical receiver further has a signal combiner connected to output a third electrical signal that is a combination of the first and second electrical signals.

According to another embodiment, provided is a signal-processing method having the steps of: optically mixing an optical input signal and an optical local-oscillator signal to generate first, second, third and fourth mixed optical signals; generating a first electrical signal in response to receiving the first and second mixed optical signals in respective first and second photo-detectors connected for differential detection; generating a second electrical signal based on the third and third mixed optical signals in respective third and fourth photo-detectors connected for differential detection; and combining the first electrical signal and the second electrical signal to generate a third electrical signal. The optical input signal can be an optical suppressed-carrier signal whose amplitude is modulated by an analog or digital message signal. The resulting third electrical signal can be either a baseband signal that is proportional to the message signal or an intermediate-frequency signal whose amplitude is modulated by the message signal.

### BRIEF DESCRIPTION OF THE DRAWINGS

Other aspects, features, and benefits of various embodiments of the invention will become more fully apparent, by way of example, from the following detailed description and the accompanying drawings, in which:

FIG. 1 shows a block diagram of an optical receiver according to one embodiment of the invention; and

FIG. 2 shows a block diagram of a signal combiner that can be used in the optical receiver of FIG. 1 according to one embodiment of the invention.

### DETAILED DESCRIPTION

One example of a suppressed-carrier signal is a double-sideband suppressed carrier (DSB-SC) signal. Amplitude A(t) (e.g., the amplitude of the electric or magnetic field) of a DSB-SC signal is often related to message signal m(t) and amplitude A_{c} of the optical-carrier signal approximately as expressed by Eq. (1):

A(t)=A_{c}|m(t)| (1)

As used herein, the term “amplitude” refers to the magnitude of change in the oscillating variable with each oscillation at the corresponding optical carrier frequency. Therefore, amplitude A(t) is a substantially instantaneous value that can change over time on a time scale that is slow compared to the period of the optical wave. Typically, message signal m(t) is a band-limited, analog, radio-frequency (RF) or audio-frequency signal. Since a typical value of the optical-carrier frequency is on the order of 100 THz, the bandwidth of message signal m(t) is much smaller than the optical-carrier frequency. The spectrum of an ideal DSB-SC signal is often substantially symmetrical with respect to the carrier frequency and often has no isolated carrier-frequency component. The power of the signal is primarily contained in the modulation sidebands that are located at frequencies below and above the carrier frequency. If m(t) is a polar binary data signal, then Eq. (1) represents a Binary Phase-Shift Keying (BPSK) modulation format.

Other examples of suppressed-carrier modulation include but are not limited to single-sideband (SSB) modulation and vestigial-sideband (VSB) modulation. Representative optical transmitters that can be used to generate optical suppressed-carrier signals are disclosed, e.g., in (1) C. Middleton and R. DeSalvo, “Balanced Coherent Heterodyne Detection with Double Sideband Suppressed Carrier Modulation for High Performance Microwave Photonic Links,” 2009 IEEE Avionics, Fiber-Optics, and Photonics Technology Conference (AVFOP'09), Digital Object Identifier: 10.1109/AVFOP.2009.5342725, pp. 15-16, (2) A. Siahmakoun, S. Granieri, and K. Johnson, “Double and Single Side-Band Suppressed-Carrier Optical Modulator Implemented at 1320 nm Using LiNbO₃ Crystals and Bulk Optics,” and (3) S. Xiao and A. M. Weiner, “Optical Carrier-Suppressed Single Sideband (O-CS-SSB) Modulation Using a Hyperfine Blocking Filter Based on a Virtually Imaged Phased-Array (VIPA),” IEEE Photonics Technology Letters, 2005, v. 17, No. 7, pp. 1522-1524, all of which are incorporated herein by reference in their entirety. Additional aspects of making and using optical transmitters for generating optical suppressed-carrier signals are disclosed, e.g., in U.S. Pat. Nos. 7,574,139, 7,379,671, 7,149,434, 6,525,857, and 6,115,162, all of which are incorporated herein by reference in their entirety.

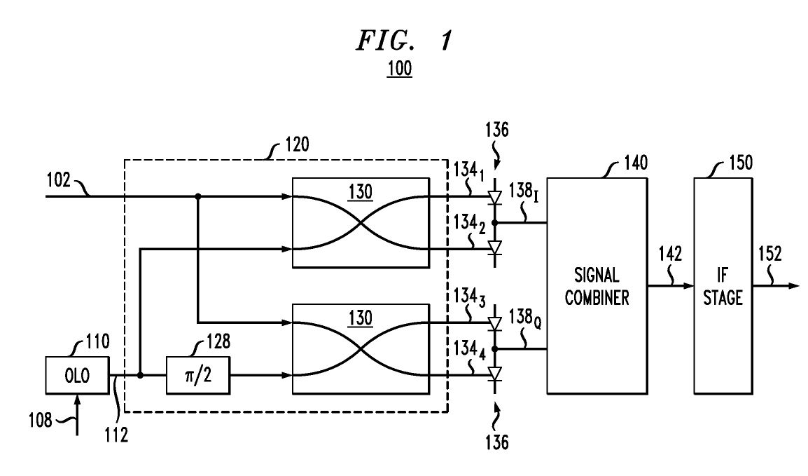

FIG. 1 shows a block diagram of an optical receiver 100 according to one embodiment of the invention. Optical receiver 100 implements coherent quadrature detection of an optical signal, e.g., a suppressed-carrier signal, received at an optical input 102 to recover a corresponding analog message signal (e.g., a baseband signal), such as message signal m(t) of Eq. (1). Depending on the frequency of an optical local-oscillator (OLO) signal that OLO source 110 applies to an optical input 112, optical receiver 100 may generate at an electrical output 142 a baseband signal or an intermediate-frequency signal. The intermediate-frequency signal has a frequency that is intermediate between the baseband-frequency band and the frequency of the optical carrier. In embodiments where the electrical output 142 outputs an intermediate-frequency signal, the optical receiver 100 includes an intermediate-frequency (IF) stage 150, e.g., to transform the intermediate-frequency signal to a corresponding baseband signal. For example, IF stage 150 can be used when the frequency of the OLO signal applied to input 112 differs from the optical-carrier frequency of the input signal received at input 102 by a relatively large amount or when either the optical carrier or the OLO have a time-varying frequency, e.g., due to a relatively large line width. IF stage 150 may be absent when the frequency of the OLO signal at input 112 is relatively close or substantially identical to the carrier frequency of the input signal at input 102.

In one embodiment, OLO source 110 is a tunable light source (e.g., a tunable laser) that can change the frequency of the OLO signal based on a control signal received at an input terminal 108. In one embodiment, the control signal received at terminal 108 enables OLO source 110 to generate the OLO signal with a phase and/or frequency locked to the carrier-frequency wave of the optical signal received at input 102. In another embodiment, OLO source 110 is not phase and/or frequency locked to the carrier-frequency of the optical signal at input 102, and the control signal configures the OLO source to generate the OLO signal with a frequency offset between the OLO signal and the carrier frequency of the input signal. In one configuration, the frequency offset is selected to fall outside a specified frequency band of interest, said band having an upper limit and a lower limit. In one exemplary embodiment, the center frequency of said frequency band of interest is located between about 2 GHz and about 18 GHz and has a 3-dB bandwidth not greater than about 4 GHz. In alternative embodiments, other suitable frequency-offset values may also be used.

An optical hybrid 120 mixes an input signal received at optical input 102 and an OLO signal received at optical input 112 to generate four separate mixed optical signals at optical outputs 134₁-134₄. The various mixed signals are combinations of the optical signals from the optical inputs 102 and 112 with different relative phases.

In the illustrated embodiment, each of the optical signals received at inputs 102 and 112 is power split into two signals, e.g., two signals of about the same intensity produced via processing with a conventional 3-dB power splitter (not explicitly shown in FIG. 1). A relative phase shift of about 90 degrees (about π/2 radian) is applied to one copy of the OLO signal using a phase shifter 128. The various signal copies are then optically mixed as shown in FIG. 1 using two 2×2 optical-signal mixers 130, which produce interfered signals at output ports 134₁-134₄. In an alternative embodiment, a relative phase shift of 90 degrees can be applied to one copy of the input signal received via optical input 102 instead of being applied to the OLO signal.

Various optical mixers are suitable for implementing optical hybrid 120. For example, some suitable optical mixers for implementing optical hybrid 120 may be commercially available from Optoplex Corporation of Fremont, Calif., and CeLight, Inc., of Silver Spring, Md. Various additional optical hybrids and MMI mixers that can be used to implement optical hybrid 120 in alternative embodiments of optical receiver 100 are disclosed, e.g., in (1) U.S. Patent Application Publication No. 2010/0158521, (2) U.S. Patent Application Publication No. 2011/0038631, (3) International Patent Application No. PCT/US09/37746 (filed on Mar. 20, 2009), and (4) U.S. Patent Application Publication No. 2010/0054761, all of which are incorporated herein by reference in their entirety.

For i=1 . . . 4, the electric field Eᵢ in mixed signal at the optical output 134ᵢ is given by Eq. (2):

$$[ \begin{matrix}{E}_{1} \\ {E}_{2} \\ {E}_{3} \\ {E}_{4}\end{matrix} ] = \frac{B}{2} [ \begin{matrix}{E}_{S} - {E}_{R} \\ - j {E}_{S} - j {E}_{R} \\ - j {E}_{S} + {E}_{R} \\ - {E}_{S} + j {E}_{R}\end{matrix} ] \qquad ( 2 )$$

where B is a constant (with |B|≦1), E_{S} is the electric field in the signal at optical input 102, and E_{R} is the electric field in the OLO signal at optical input 112. Eq. (2) indicates that the individual optical signals at the various optical outputs 134₁-134₄ correspond to different mixtures of input electric fields E_{S} and E_{R}. In particular, at optical outputs 134₁, 134₂,134₃, and 134₄, the initially input signals E_{S} and E_{R} are combined with the respective relative phases of about 180, 0, 270, and 90 degrees. In various alternative embodiments, optical hybrid 120 can be implemented to mix the received optical signals with relative phases that deviate from 180, 0, 270, and 90 degrees, e.g., by about ±10 degrees.

Optical signals at outputs 134₁-134₄ are detected by four corresponding photo-detectors (e.g., photodiodes) 136 that are electrically connected to form balanced pairs as indicated in FIG. 1. The two photo-detectors 136 that receive mixed optical signals from the optical outputs 134₁ and 134₂ generate an electrical analog signal (e.g., photocurrent) at an electrical port 138_{I}. The two photo-detectors 136 that receive the mixed optical signals from outputs 134₃ and 134₄ generate an electrical analog signal (e.g., photocurrent) at an electrical port 138_{Q}. In a representative embodiment, photo-detectors 136 may also work as low-pass filters that reject the sum frequency generated due to the photo-detector's square-law conversion of optical signals into electrical ones. Eqs. (3a) and (3b) provide expressions for electrical signals at electrical output ports 138_{I} and 138_{Q}, respectively:

S_{I}∝S₀m(t)cos(Δωt+Δφ) (3a)

S_{Q}∝S₀m(t)sin(Δωt+Δφ) (3b)

where S₀ is a constant; m(t) is the message signal (also see Eq. (1)); Δω is the frequency difference, i.e., ω_{OLO}-ω_{OC}, between the frequency ω_{OLO} of the OLO signal received at optical input 112 and the frequency ω_{OC} of the optical carrier received at optical input 102; and Δφ is the difference between the time-independent portion of the phase of the OLO signal received at optical input 112 and the time-independent portion of the phase of the optical carrier received at optical input 102. Note that Eqs. (3a)-(3b) assume that both the optical-carrier signal used at the transmitter and the OLO signal have substantially constant amplitudes, which are folded into S₀.

Eqs. (3a) and (3b) reveal that electrical signals at ports 138_{I} and 138_{Q} have a time independent phase shift with respect to one another of about 90 degrees and can be interpreted as each providing a measure of the Cartesian components of a two-dimensional vector, V=(S_{I},S_{Q}), with S_{I} and S_{Q} being the in-phase and quadrature-phase components, respectively, of vector V. If Δω is not zero, then vector V rotates about the origin at an angular speed of Δω radians per second. If Δω is substantially zero, then vector V is oriented with respect to the X-coordinate axis at an approximately constant angle of Δφ. The length of vector V is proportional to value of the message signal m(t).

Signal combiner 140 adds the electrical signals received at electrical ports 138_{I} and 138_{Q} to produce a combined electrical analog signal at an electrical output port 142. Depending on frequency difference Δω, signal 142 can be an intermediate-frequency signal or a baseband signal. In various embodiments, signal combiner 140 can be designed so that, in the process of generating the electrical output signal at electrical output port 142 from signals at electrical ports 138_{I} and 138_{Q}, signal combiner 140 performs, without limitation, one or more of the following signal-processing operations: (i) generate a linear combination of the two input signals; (ii) generate a signal corresponding to a vector sum of the two signals; (iii) rectify a signal; (iv) determine an amplitude of a signal; (v) determine a phase offset between the two signals; (vi) square a signal; (vii) apply low-pass filtering; and (viii) apply band-pass filtering. Signal combiner 140 is configured to perform one or more of these operations in a manner that causes the overall signal processing implemented in the signal combiner to accomplish at least one of the following objectives: (i) alleviate the adverse effects of frequency fluctuations on the signal produced at electrical output port 142 and (ii) alleviate the adverse effects of phase noise and/or drift on the signal produced at electrical output port 142.

For example, the signal combiner 140 may be an electrical power combiner configured to generate the electrical output signal at port 142 to be proportional to a sum of squared signals received from electrical ports 138_{I} and 138_{Q} in accordance with Eq. (4):

S_{c}²∝S_{I}²+S_{Q}² (4)

where S_{c} is the signal at electrical output port 142, and the remaining notations are the same as in Eqs. (3). Since sin² x+cos² x≡1, Eqs. (3a), (3b), and (4) imply that S_{c}² is proportional to [m(t)]². For that reason, the magnitude of the message signal m(t) can be recovered efficiently from signal at electrical output port 142 regardless of the difficult-to-control (1) frequency offset between the optical input signal at port 102 and the OLO signal at port 112, (2) phase noise, and/or (3) phase drift, provided that the frequency components corresponding to the frequency/phase fluctuations fall outside the frequency band that is passed by electrical filtering of the photo-detectors 136 or signal combiner 140. For illustration, the amplitude of in-phase baseband signal at the electrical port 138_{I} (S_{I}, Eq. (3a)) is close to zero when Δωt+Δφ≈90 degrees, which causes message signal m(t) to be greatly attenuated in the signal at electrical port 138_{I} and/or become completely unrecoverable from that signal alone. Similarly, the amplitude of the quadrature-phase baseband signal at electrical port 138_{Q} (S_{Q}, Eq. (3b)) is close to zero when Δωt+Δφ≈0, which causes message signal m(t) to be greatly attenuated in the signal at electrical port 138_{Q} and/or become completely unrecoverable from that signal alone.

As already indicated above, IF stage 150 is optional and may be used when OLO source 110 is detuned from the optical carrier frequency of the signal received at optical input 102 by a relatively large amount. For example, when the OLO frequency is close to the optical-carrier frequency, IF stage 150 may be removed or replaced by an appropriate electrical band-pass filter. When the frequency offset is relatively large, IF stage 150 can be similar to that used in a conventional superheterodyne radio receiver. An electrical output signal at port 152 produced by IF stage 150 is a baseband signal corresponding to message signal m(t). In various embodiments, the output signal at port 152 can be a digital electrical signal or an analog electrical signal. Representative electrical IF demodulators that can be used to implement IF stage 150 are disclosed, e.g., in U.S. Pat. Nos. 7,916,813, 7,796,964, 7,541,966, 7,376,448, and 6,791,627, all of which are incorporated herein by reference in their entirety.

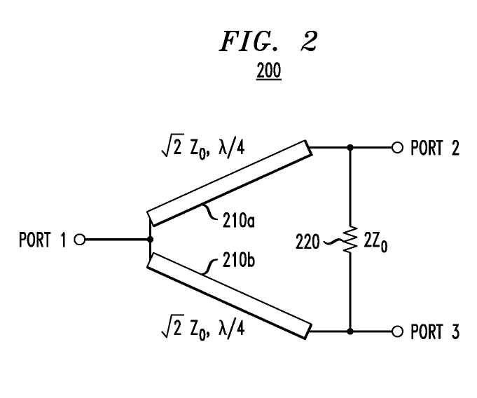

FIG. 2 shows a block diagram of a signal combiner 200 that can be used as signal combiner 140 according to some embodiments. Combiner 200 is a Wilkinson-type power combiner/divider. When combiner 200 is configured as signal combiner 140, Port 2 and Port 3 are connected to receive the signals output from electrical output ports 138_{I} and 138_{Q}, respectively, and Port 1 is connected to deliver an electrical signal output at electrical output port 142 (also see FIG. 1).

Combiner 200 has two quarter-wave micro-strip lines 210a and 210b, both connected, at one end, to Port 1 and then connected, at the other end, to Port 2 and Port 3, respectively. Combiner 200 further has a ballast resistor 220 connected between Port 2 and Port 3. Each of micro-strip lines 210a and 210b has an impedance of \sqrt{2}Z₀, and ballast resistor 220 has an impedance of 2Z₀, where Z₀ may be, e.g., about the impedance of the external lines connected to the different ports of combiner 200.

Note that, when combiner 200 is used in optical receiver 100 designed for intermediate-frequency operation, the wavelength λ that defines the length of quarter-wave micro-strip lines 210a and 210b may be, e.g., about equal to the wavelength of a wave corresponding to the expected intermediate frequency, f, in the relevant medium, where f=2πΔω. Due to the fact that signals at electrical ports 138_{I} and 138_{Q} do not have equal power all the time, combiner 200 may have some insertion losses. These losses may be, however relatively low, and Ports 2 and 3 may remain well isolated from one another, which can advantageously reduce crosstalk between the ports. In some embodiments, the power imbalance between the signals at Ports 2 and 3 (or ports 138_{I} and 138_{Q}) can be mitigated using transmission-line sections with different impedances or incorporating an additional transmission-line section of appropriate length, for delaying one input of the combiner with respect to the other, and resulting in a compensating phase shift of about 90°. Output signal at electrical output 142 of signal combiner 200 typically represents a linear combination of signals at electrical ports 138_{I} and 138_{Q}.

In alternative embodiments, signal combiner 200 can be modified to include additional stages and/or circuit elements, e.g., as described in the following publications: (1) A. Grebennikov, “Power Combiners, Impedance Transformers and Directional Couplers: Part II,” High Frequency Electronics, January 2008, pp. 42-53, and (2) R. H. Chatim, “Modified Wilkinson Power Combiner for Applications in the Millimeter-Wave Range,” Master Thesis, 2005, University of Kassel, Germany, both of which are incorporated herein by reference in their entirety. These modifications can be made, e.g., to improve manufacturability of the combiner, change its frequency characteristics, and/or improve isolation between the various ports. Additional aspects of making and using signal combiners that can be used to implement signal combiners 140 and 200 are disclosed, e.g., in U.S. Pat. Nos. 7,750,740, 6,018,280, and 5,872,491, all of which are incorporated herein by reference in their entirety.

While this invention has been described with reference to illustrative embodiments, this description is not intended to be construed in a limiting sense.

For example, various functions of signal combiner 140 (FIG. 1) can be implemented in the digital domain using the concomitant analog-to-digital conversion and appropriate software. Alternatively, optical signals at outputs 134₁-134₄ may be converted into electrical digital signals using single diodes instead of balanced pairs and then a subtraction operation can be applied to these electrical signals to generate electrical signals 138_{I} and 138_{Q} in the digital domain. Computations in the digital domain can be performed using software or in suitable hardware, such as an FPGA, ASIC, or microprocessor. Power combining of signals 138_{I} and 138_{Q} can be implemented by squaring the corresponding digital values in software or hardware. Alternatively or in addition, the use of various active-circuit elements coupled to the photodiodes may be implemented to accomplish the various desired signal-combining functions in hardware.

Various modifications of the described embodiments, as well as other embodiments of the invention, which are apparent to persons skilled in the art to which the invention pertains are deemed to lie within the principle and scope of the invention as expressed in the following claims.

Unless explicitly stated otherwise, each numerical value and range should be interpreted as being approximate as if the word “about” or “approximately” preceded the value of the value or range.

It will be further understood that various changes in the details, materials, and arrangements of the parts which have been described and illustrated in order to explain the nature of this invention may be made by those skilled in the art without departing from the scope of the invention as expressed in the following claims.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

The description and drawings merely illustrate the principles of the invention. It will thus be appreciated that those of ordinary skill in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

What is claimed is:

1. An optical receiver, comprising:
an optical hybrid configured to mix an optical signal received at a first optical input port thereof with an optical local-oscillator signal received at a second optical input port thereof to generate first, second, third, and fourth mixed optical signals at respective first, second, third and fourth optical output ports thereof;
a first optical-to-electrical (O/E) converter including first and second photo-detectors connected to receive optical signals from the respective first and second optical output ports, the first O/E converter having a first electrical port that outputs a first electrical signal representative of a difference between electrical signals produced by the respective first and second photo-detectors;
a second O/E converter including third and fourth photo-detectors connected to receive optical signals from the respective third and fourth optical output ports, the second O/E converter having a second electrical port that outputs a second electrical signal representative of a difference between electrical signals produced by the respective third and fourth photo-detectors; and
a signal combiner connected to output a third electrical signal that is a combination of the first and second electrical signals.

2. The optical receiver of claim 1, wherein, when the optical signal received at the first optical input port is an optical suppressed-carrier signal having an amplitude that is modulated by an analog or digital message signal, then the third electrical signal is either a baseband signal that is proportional to the message signal or an intermediate-frequency signal having an amplitude that is modulated by the message signal.

3. The optical receiver of claim 1, wherein the optical hybrid is configured to generate said first, second, third and fourth mixed optical signals to be mixtures of the optical signals received at the first and second optical input ports with different relative phases.

4. The optical receiver of claim 1, further comprising a light source configured to generate the optical local-oscillator signal so that an electrical-carrier frequency of the third electrical signal is controlled by a frequency of the optical local-oscillator signal.

5. The optical receiver of claim 4, wherein the light source is not phase-locked to a frequency of the optical input signal received at the first optical input port of the optical hybrid.

6. The optical receiver of claim 1, wherein the signal combiner is configured to output the third electrical signal whose electrical power is about proportional to a sum of electrical powers of the first electrical signal received from the first O/E converter and the second electrical signal received from the second O/E converter.

7. The optical receiver of claim 1, wherein the signal combiner is configured to output the third electrical signal that is about proportional to a sum of about a square of the first electrical signal received from the first O/E converter and about a square of the second electrical signal received from the second O/E converter.

8. The optical receiver of claim 1, further comprising an intermediate frequency demodulator configured to process the third electrical signal to generate an electrical baseband signal corresponding to the optical signal received at the first optical input port.

9. The optical receiver of claim 1, wherein the optical hybrid comprises:
a first optical splitter configured to split the optical input signal into a first attenuated copy and a second attenuated copy;
a second optical splitter configured to split the optical local-oscillator signal into a first attenuated copy and a second attenuated copy;
a first optical mixer configured to mix the first attenuated copy of the optical input signal and the first attenuated copy of the optical local-oscillator signal to generate the first and second mixed optical signals; and
a second optical mixer configured to mix the second attenuated copy of the optical input signal and the second attenuated copy of the optical local-oscillator signal to generate the third and fourth mixed optical signals.

10. The optical receiver of claim 1, wherein the signal combiner is configured to produce the third electrical signal to be a linear combination of the first electrical signal and the second electrical signal.

11. The optical receiver of claim 1, wherein the signal combiner comprises:
a first micro-strip line connected between a first port and a second port;
a second micro-strip line connected between the first port and a third port; and
a resistor connected between the second port and the third port, wherein:
the second port is connected to receive the first electrical signal;
the third port is connected to receive the second electrical signal; and
the first port is connected to output the third electrical signal.

12. The optical receiver of claim 1, wherein the signal combiner is a Wilkinson-type power combiner having one or more stages.

13. The optical receiver of claim 1, wherein the signal combiner comprises a digital circuit configured to combine the first electrical signal and the second electrical signal in digital form.

14. A signal-processing method, comprising:
optically mixing an optical input signal and an optical local-oscillator signal to generate first, second, third and fourth mixed optical signals;
generating a first electrical signal in response to receiving the first and second mixed optical signals in respective first and second photo-detectors connected for differential detection;
generating a second electrical signal based on the third and third mixed optical signals in respective third and fourth photo-detectors connected for differential detection; and
combining the first electrical signal and the second electrical signal to generate a third electrical signal.

15. The method of claim 14, wherein:
the optical input signal is an optical suppressed-carrier signal having an amplitude that is modulated by an analog or digital message signal; and
the third electrical signal is either a baseband signal that is proportional to the analog message signal or an intermediate-frequency signal having an amplitude that is modulated by the message signal.

16. The method of claim 14, wherein said first, second, third and fourth mixed optical signals are being generated be mixtures of the optical input signal and the optical local-oscillator signal with different relative phases.

17. The method of claim 14, wherein the third electrical signal is being generated with its electrical power being about proportional to a sum of electrical powers of the first electrical signal and the second electrical signal.

18. The method of claim 14, wherein the optical local-oscillator signal comprises is not phase-locked to a frequency of the optical input signal.

19. The method of claim 14, wherein the third electrical signal is a linear combination of the first electrical signal and the second electrical signal.

20. The method of claim 14, wherein the step of combining comprises:
about squaring the first electrical signal;
about squaring the second electrical signal; and
generating the third electrical signal based on about a sum of said squares of the first electrical signal and the second electrical signal.
